(19) United States
(12) Patent Application Publication
(10) Pub. No.: US 2003/0226750 A1
(43) Pub. Date: Dec. 11, 2003

(54) Electrospray dispersion in an alternating current mode

(76) Inventor: John B. Fenn, Richmond, VA (US)

Correspondence Address: CONN. ANALYTICAL CORP., Att: Joseph J. Bango, Jr., 696 AMITY ROAD, BETHANY, CT, 06524, US

(21) Appl. No.: 10/460,725

(22) Filed: Jun. 11, 2003

Related U.S. Application Data
(60) Provisional application No. 60/387,608, filed on Jun. 11, 2002.

(51) Int. Cl. H05F 3/00

(52) U.S. Cl. 204/164

(57) ABSTRACT

An improved method of controlling stability and deposition of electrospray jets which eliminates a charge accumulation the electrospray jet, source or target is described. Utilizing an alternating rather than a direct or constant electric potential for electrospray production, accumulated charge is neutralized. Applications include improved surface deposition, controlled electrospinning, and simplified spacecraft electric propulsion, to name a few.

### CROSS-REFERENCE TO RELATED APPLICATIONS

Provisional App. No. 60/387,608 was filed on Jun. 11, 2002

### BACKGROUND OF THE INVENTION

Between 1910 and 1920 John Zeleny carried out the first reported experiments on the electrostatic dispersion of a conducting liquid into a fine spray of charged droplets by passing a stream of liquid was through a small bore tube maintained at a high potential relative to an opposing counter electrode. It is now realized that because of the resulting intense electric field at the tip of that tube or “needle” (so called because the tube often comprises a short length of the tubing used to make hypodermic “needles”) the emerging liquid forms a conical meniscus known as a “Taylor Cone” after G. I. Taylor who much later explained this shape in terms of a competition between the surface tension of the liquid and the repines of its dipoles to the electric field. If the liquid contains enough anions and cations to provide even a small electrical conductivity, a tiny filament or jet of liquid emerges from the tip of the cone and flows toward the opposing electrode. Because of the intense field at the needle tip the departing liquid has an excess of either cations or anions on its surface, depending on the polarity of the field. As the jet of liquid flows toward the counter electrode the interplay between the surface tension and the viscosity of the liquid results in the formation of so-called varicose waves on the jet surface. These waves increase in amplitude, finally truncating the jet into a sequence of monodisperse droplets, which are highly charged due to the excess of cations or anions on their surfaces. The resulting Coulomb repulsion causes their trajectories to diverge into a conical array forming a so-called “electrospray” of tiny charged droplets

Zeleny noted that as each charged droplet evaporated it would suddenly disrupt into a plurality of smaller droplets, a phenomenon that had been predicted and characterized by Lord Rayleigh in 1882. Rayleigh realized that as evaporation of solvent decreased the size of such a charged droplet the surface charge density would increase and reach what is now known as the “Rayleigh Limit” at which Coulomb repulsion overcomes the surface tension that holds the droplet together in a spherical shape. The resulting instability would disrupt the droplet into a plurality of smaller droplets, as Zeleny later observed. This “electrospray” formation of charged droplets and their subsequent disruption by evaporation, remained pretty much a laboratory curiosity for half a century. Then in 1968 Malcolm Dole proposed that this evaporation-disruption sequence might constitute a method of producing intact gas phase ions of large polymer molecules for mass analysis by the methods of mass spectrometry. He reasoned that the smaller droplets resulting from Rayleigh's instability would continue to evaporate until they too became unstable and would break up into still smaller droplets. If the original solution were sufficiently dilute, a succession of such evaporation-induced instabilities could ultimately lead to droplets so small that each one contained only a single solute molecule. As the last of the solvent evaporated from that ultimate droplet, its residual molecule would retain some of the droplet's charge to become an intact, gas phase ion. This idea was truly revolutionary because the only method then known for making an ion from a neutral atom or molecule was to bring about a gas phase encounter between such a molecule and an electron, photon or another ion that had sufficient energy to remove an electron from the molecule.

More rarely, an encounter between an electron and a neutral atom or molecule at sufficiently low energy could sometimes result in the attachment of the electron to the atom or molecule to form a negative ion. But as every chemist and cook is well aware, very large molecules such as polymer oligomers cannot be vaporized with substantial, even catastrophic decomposition. In that first paper Dole also described some experimental attempts to verify his proposed scenario, but unfortunately, for a number of reasons, his results were not sufficiently convincing to persuade others to pursue his idea. Then in 1984, Yamashita and Fenn reported that Dole's approach worked well for small molecules that were both fragile and non-volatile. Four years later they showed that it could produce intact ions of peptides and proteins with molecular weights up to at least 50,000. Moreover, those ions were multiply charged to such an extent that their mass/charge ratios were almost always less than about 3000, well within the operating range of relatively inexpensive mass spectrometers. These results precipitated what has been termed the “Electrospray Revolution.” As a result, the number of papers per year on “Electrospray Ionization Mass Spectrometry” (ESIMS) in the archival journals has risen steadily from less than five per year in 1988 to over 1500 per year in 2001! Moreover, those papers represent only a small fraction of the applications of this technique. The unpublished results of much larger and more extensive activity in ESIMS remain buried in the files of the pharmaceutical companies. It is now a rare drug that reaches market without a lot of ESIMS analyses in its discovery and testing.

Also noteworthy are many other applications of Zeleny's Electrospray Technique. In the rapidly expanding field of “Nano-technology” it is increasingly being used as a means of producing extremely small and monodisperse particles of various materials. It has also found application as a method of depositing very thin layers of solute species on various substrates. It is being pursued as a method of producing highly charged droplets of non-volatile liquids to serve as so-called “colloidal propellants” in thrusters for the propulsion of micro-satellites in space. The latter application stems from the fact that he mass-charge ratios of ES droplets are high enough so that their electrostatic acceleration can provide greater thrust at lower energy than can the ions of heavy elements that have long been the traditional “propellants” for “ion rockets”. In another rapidly growing variation of Zeleny's technique, a solution of polymer molecules in a solvent is also introduced through a small tube at high potential relative to a counter electrode. With appropriate combinations of solvent, solute, concentration, and applied voltage, the emerging liquid forms a very thin continuous fiber of the solute polymer instead of a spray of droplets. This so-called “Electrospinning” phenomenon has long been known but only recently has become the basis of intense activity; in large part because the fibers it produces can have much smaller diameters than those produced by conventional spinning technologies. Moreover, it can produce fibers from polymers that cannot be readily “spun” by those conventional technologies.

### PRIOR ART

The prior art reveals electrospray and electrospinning techniques that all incorporate the use of a constant polarity DC voltage to produce the spray, in some applications the electrospray voltage was periodically interrupted to provide short “spray-on” times to deposit very small spots of solute at precisely prescribed positions on a surface. An example of such work was that done by Yogi et al, where effective “spray-on” times were as short as 10 ms, but in which the polarity remained constant. The interruption of constant polarity does not imply AC operation, as the polarity never changes, only a reversal of polarity in time would define AC operation. This time varying polarity can be abrupt, as in the case of a square wave, of less abrupt, as in the case of a sinusoidal waveform.

### BRIEF DESCRIPTION OF THE INVENTION

In all of these applications of Zeleny's technique (i.e. allowing a liquid to emerge from a small bore tube at high potential relative to an opposing counter-electrode) the voltage applied to the injection “needle” has always been at a constant polarity, i.e. the electro-spray dispersion is in a DC mode. In some applications the applied voltage has been periodically interrupted so as to provide short intervals of “spray on” times. For example, Yogi et al provided effective “spray on” times as short as 10 ms to deposit very small “spots” of solute at precisely prescribed positions on a surface. However, in these and other similar experiments the polarity of the sprayer and the target were the same in successive depositions, i.e. successive “spray-on” times. The subject invention stems from our surprising discovery that Electrospray Dispersion can also be carried out in an AC mode, i.e. by the application to the needle of a high voltage with a rapidly alternating polarity relative to a counter-electrode. Successive “spray-on” times then have alternating polarities. The sprays obtained in such AC operation at relatively high frequencies are visibly very similar to those obtained in the conventional DC mode. Moreover, they have also shown promise and some valuable advantages in a variety of applications.

### BRIEF DESCRIPTION OF THE DRAWINGS

FIG. 1 is a schematic representation of the essential features of a conventional apparatus for producing a DC spray of tiny charged droplets by Zeleny's technique.

FIG. 2 shows a schematic representation of an apparatus for producing an AC spray according to the disclosed invention.

FIG. 3 shows a schematic representation of an apparatus for producing a conventional DC spray.

### DETAILED DESCRIPTION OF THE INVENTION

As already indicated the essential feature of the invention is that apparently stable and continuous electrosprays can be produced by the applying to the spray needle a voltage of alternating polarity relative to a counter electrode. By way of illustration a number of examples will be described in which AC sprays show some substantial advantages relative to their DC counterparts.

Deposition of Surface Coatings

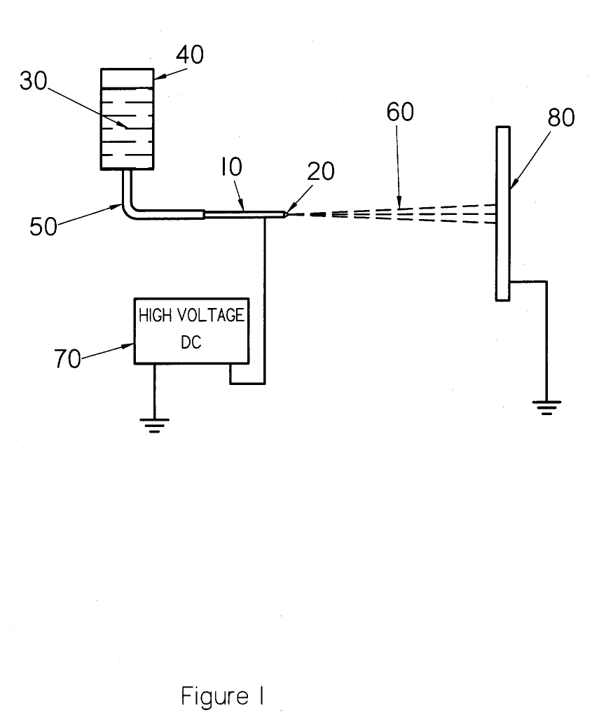

A spray needle comprising preferably a 3 cm length of stainless steel hypodermic needle tubing was mounted relative to a counter electrode comprising a flat surface in an arrangement similar to the one shown in FIG. 1. A dilute solution of the polymer, carboxymethyl cellulose in an alcohol water mixture was fed into the inlet end of the spray needle at a rate of 2 uL/min, while a 60 cycle AC potential of about 5 kilovolts (relative to the opposing grounded counter-electrode) was being applied to the needle. The distance between the needle tip and the target surface was about 3 cm. The solution emerging from the needle tip formed an electrospray of tiny droplets that was visually stable and had an appearance very similar to the spray-resulting from the application of an equivalent DC voltage. When the counter electrode surface was coated with an insulating dielectric material, no discernable deposit of carboxymethyl cellulose could be obtained because the insulating layer rapidly accumulated net charge. The resulting counter-potential diverted the arriving charged droplets and particles away from the surface. During operation with 60 cycle AC, on the other hand, a uniform coating of carboxymethyl cellulose, with thicknesses of up to at least 20 microns, could readily be deposited on that dielectric surface. Clearly, in the AC case, the alternating arrival of negatively and positively charged droplets (and/or particles) neutralized each other so that the effective potential of the surface had the same value as the underlying electrode. Thus, the deposition of droplets or particles from the spray could continue indefinitely with the result that a uniform layer of solute having almost any desired thickness could be deposited. The ability of a traditional DC electrospray to deposit, on conducting surfaces, uniform layers of various materials, with precisely controllable thicknesses and areas, has long been recognized and exploited. The ability of the invention to achieve such deposition on non-conducting surfaces opens up exciting possibilities in the coatings field.

Microthrusters for Space Propulsion

The electrostatic acceleration of charged droplets of non-volatile liquids as the basis of “micro-thrusters” for adjusting the positions of very small satellites is being actively pursued by both NASA and the Defense Department for some space missions. In all such “colloidal propellant” projects the ejected particles all have the same polarity, usually positive. Consequently, provision must be made to prevent cumulative charging of the vehicle by ejection of as much negative charge as departs the vehicle in the positively charged droplets that produce the desired thrust. Current practice is to provide a separate system to eject enough electrons or negative ions from the vehicle to maintain vehicle neutrality. Electron ejection systems are simpler but constitute a waste of valuable energy with negligible production of thrust because electrons have such a low mass that their exit momentum is essentially negligible even at very high velocities (i.e. energies). Ejection of negatively charged particles with appreciable mass, e.g. heavy ions or charged droplets, produce useful thrust but are just as complex in construction and operation as are the “primary” thruster whose operation gives rise to the need for negative charge ejection. In sum, according to present practice, the need to maintain electrical neutrality in a vehicle propelled by ions or charged particles such as droplets would seem to require either a substantial increase in propulsion system complexity or a substantial decrease in overall energy efficiency.

The subject invention offers an escape from this dilemma. Operation of an electrospray thruster in the AC mode can provide equal numbers of both positively and negatively charged droplets in rapid succession. Moreover, at high enough values of AC voltage, the acceleration transit time of a droplet from its effective origin at the tip of the spray needle to the counter electrode (e.g. an open mesh grid with high “transparency” at the ground potential of the vehicle) can be a negligible fraction of the “spray-on” time for each cycle. Consequently, the net loss of both thrust and energy during the time of transition from one polarity to the other can be made negligibly small. There is also the possibility that for a given propellant liquid the number of charges ejected per unit time may be different when the polarity of the spray is positive, than when the polarity is negative. In that case one can electronically adjust the relative duration's of the positive and negative phases of a cycle so that the time-averaged numbers of positive and negative charges ejected, are the same. In sum, the additional degree of freedom offered by AC operation of electrospray thrusters can maximize both their thrust and energy efficiencies.

With respect to the possibility of electronic control of the relative duration's of the positive and negative spray polarities it is to be remembered that the basic power source for most microsatellites is likely to be solar energy, which is intrinsically DC in nature. The most convenient way of obtaining the high voltages that are needed for electrospraying will be to convert the DC output of the solar cells into AC which can readily be stepped up by a transformer to produce a high voltage output. It turns out that it is in fact easier to convert a DC current into a square wave AC current, than into the sine wave AC current that is the natural output of the rotating armatures that produce most of the power that runs the factories, farms and households of the modern world. With the very fast on-off switches that are readily available and relatively inexpensive, it is straightforward to produce a square wave AC current in which the duration of the current pulse at negative and positive polarities can be readily varied in almost any desired pattern.

What at first glance may seem surprising is that the rather complex system of Taylor-cone-jet-droplet-formation can respond so quickly to rapid polarity reversal. When one considers that the number of droplets formed per unit time is really huge, and that the transit time from needle to counter electrode is a small fraction of a millisecond, it becomes clear that, the time is takes for the system to adjust to a change in voltage is a small fraction of the cycle time at even relatively high frequencies of polarity alternation.

Mass Spectrometry

By far the most widespread current use of electrospray dispersion of liquids is in so-called Electrospray Ionization Mass Spectrometry (ESIMS). In this application a dilute solution containing one or more solute species is dispersed into gas usually at near atmospheric pressure. By a much debated mechanism, evaporation of solvent from the charged droplets transforms any polar solute species into intact gaseous ions comprising solute anions or cations or adducts of such ions with otherwise neutral solute polar molecules. The resulting ions can have multiple charges, the number being determined by the size of the molecule and the number of its polar atoms or groups. In the case of proteins and peptides for example, the adduct charges are usually protons which add to the molecule's basic residues in sufficient numbers to reduce the mass/charge ratios of the resulting ions to below 3000, no matter how large is the parent molecule. Moreover, any particular molecular species gives rise to ions with a range of charge multiplicities. Consequently, the resulting mass spectrum comprises for each such species a coherent sequence of peaks, the ions of each peak differing from those of adjacent peaks by a single charge. At first glance the apparent complexity of such a spectrum would seem to make its interpretation hopeless. However, the coherence of the sequence allows available computer algorithms to identify the peaks in a sequence that are due to a particular parent molecule. Thus each peak in the sequence becomes an independent measure of the mass of the parent molecule. Averaging over of these independent measures thus provides a much more reliable value for the molecular weight of the parent molecule than could possibly obtained from any single measurement. Moreover, these algorithms can quickly analyze even the most complex of spectra and provide an accurate value of molecular weight for each component in a sample comprising a large number of such components. It has further emerged that ESI can produce intact ions from very fragile species with molecular weights of 100 million or more!

Many of these remarkable features of ESI were first reported in paper by Meng, Mann and Fenn in 1988. Since then the practice of ESIMS has been growing exponentially. The number of papers per year on ESIMS in the archival journals has grown from 4 or 5 in 1988 to over 1500 in 2001 with no signs yet of any decrease in that rate of growth. Moreover, the results of a far larger activity are not published but remain buried in the files of the pharmaceutical companies. All of this ESIMS work has been carried out with ESI in the DC mode but the AC sprays of the subject invention reveal some very intriguing possibilities. A well-established methodology known as Tandem Mass Spectrometry or MS-MS has become a very powerful tool in determining the structure and composition of large biomolecules such as proteins and nucleic acids. In this technique one determines mass/charge ratio of ES ions of a molecule in a first mass analysis step and then fragments those ions by one of several methods, e.g. high energy collisions with neutral molecules. The mass/charge ratios of the resulting fragment ions are then determined in a second mass analysis. The masses of these fragment ions provide a lot of information on the structure and composition of the parent ion. Originally this informative analysis of fragments of parent ions was carried out with a succession of quadrupole analyzers sometimes referred to as “quadrupole mass filters” because they passed only those ions having a particular mass/charge ratio (Hence the term, quadrupole mass filter.) The passed ions were then accelerated into a second quadrupole which allowed all ions to pass but kept them confined to near the axis of that second quadrupole. A small but finite pressure of neutral molecules was maintained in that second quadrupole. The ions of particular mass charge ration accelerated from the first quadrupole under “triple quadrupole mass spectrometer” configuration, a first quadrupole passed ions having a selected mass/charge ratio. Separated by a third quadrupole which in sequence technique a number of methods have been used to achieve the fragmentation including energetic collisions with inert stable neutral molecules such as argon, collisions with surfaces, exposure to high energy photons, e.g. from a laser, and “heating” of trapped ions by black-body radiation from hot surfaces. Recently there has been increasing use of fragmentation by the energy released when at least one of the charges of a multiply charged ion is neutralized by a free electron.

FIG. 1: A spray needle 10 comprising a short (2 or 3 cm) length of stainless steel hypodermic needle tubing is mounted relative to a counter electrode 80 comprising a flat surface. A container 40 holds a conductive solution 30 of an alcohol water mixture. This dilute solution 30 is then fed into the inlet end of the spray needle 10 through a connecting tube 50 while a DC potential of several kilovolts 70 (relative to the opposing grounded counter-electrode 80) is applied to the needle 10. The charge buildup at the tip of the needle 10 gives rise to what is referred to as a Taylor cone 20 and forms an electrospray 60 of tiny droplets.

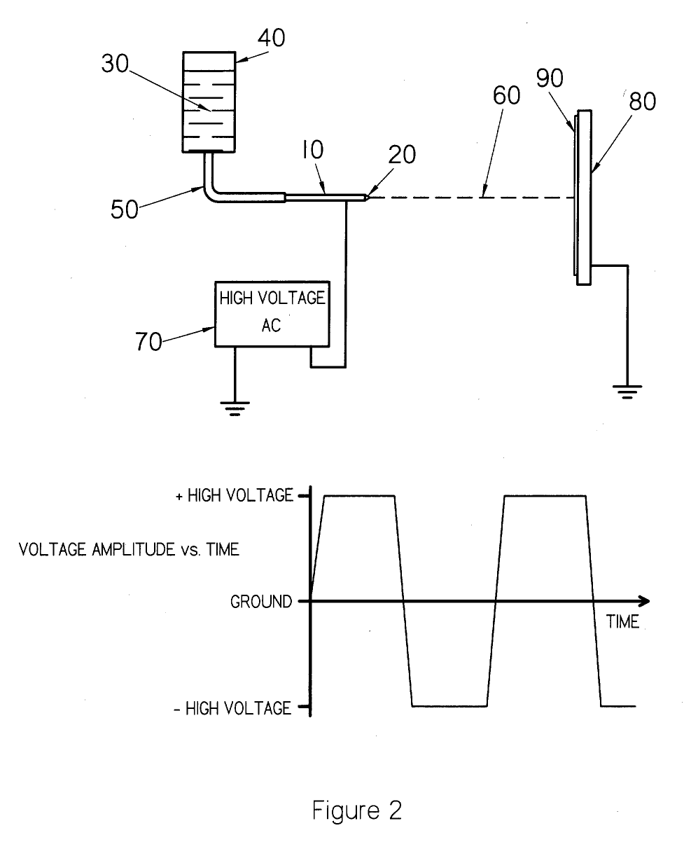

FIG. 2: A spray needle 10 comprising a 3 cm length of stainless steel hypodermic needle tubing is mounted relative to a counter electrode 80 comprising a flat surface in an arrangement similar to the one shown in FIG. 1. The counter electrode 80 is coated with an insulating dielectric material 90. A container 40 holds a dilute solution 30 of the polymer to be electrospun combined with an alcohol water mixture while a 60 cycle AC potential of about 5 kilovolts 70 (relative to the opposing grounded counter-electrode 80) was being applied to the needle 10. The solution 30 is then fed into the inlet end of the spray needle 10 through a connecting tube 50 while a AC potential of about 5 kilovolts (relative to the opposing grounded counter-electrode 80) is applied to the needle 10. The solution 30 emerging from the Taylor cone 20 at the needle tip forms an electrospray 60 of tiny droplets that is visually stable and does not need a beta or electron source to remove surface charge buildup as in the case of a DC voltage.

In summation, alternating the electric field with respect to time the applied potential of an electrospray or electrospinning procedure yields an advantage of neutralizing any charge buildup on the electrospray apparatus, such as the case with a spacecraft, or on the jet stream itself, as with the case of electrospinning. Use of AC with electrospray improves surface deposition of a desired species. Patent priority extends to any wave shape, sine or square, transient, random, or any variation thereof, which is repetitive in nature and incorporates a change in polarity. The change in polarity includes alternating the electrospray source with respect to the opposing collector electrode or alternating the polarity between the source and collectors themselves.

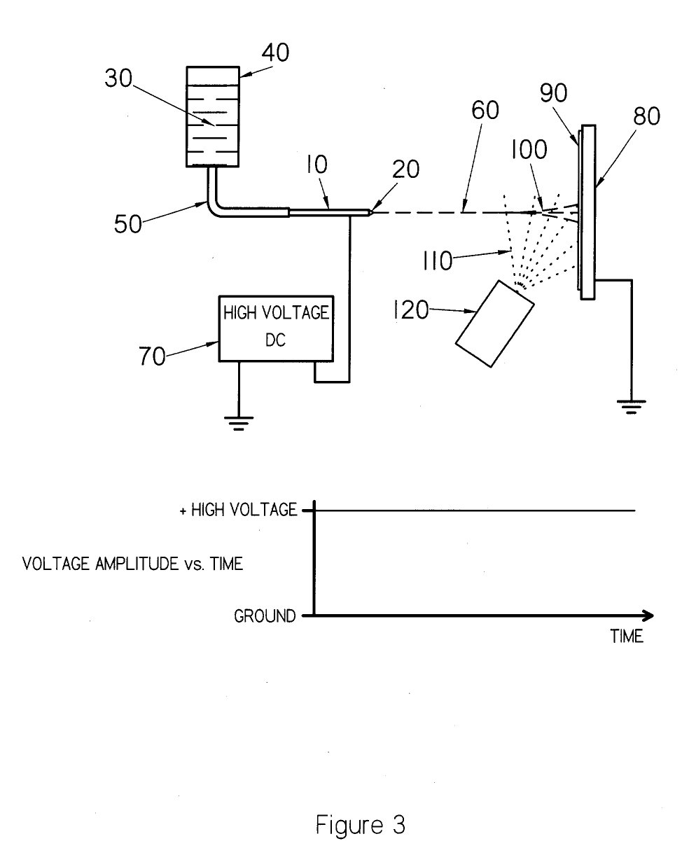

FIG. 3: A spray needle 10 comprising a 3 cm length of stainless steel hypodermic needle tubing is mounted relative to a counter electrode 80 comprising a flat surface. The counter electrode 80 is coated with an insulating dielectric material 90. container 40 holds a dilute solution 30 of the polymer to be electrospun combined with an alcohol water mixture. This solution 30 is then fed into the inlet end of the spray needle 10 through a connecting tube 50 while a DC potential of about 5 kilovolts 70 (relative to the opposing grounded counter-electrode 80) is applied to the needle 10. The solution 30 emerging from the Taylor cone 20 at the needle tip forms an electrospray 60 of tiny droplets that is visually stable for a short distance and then begins to “whip” 100 around wildly. This “whipping” effect has the great disadvantage of causing a large deviation of polymer placement on the target electrode 80 and non-uniform deposition thickness. To reduce the “whipping” effect, a charge neutralizer 120 must be used to remove the built up charge on the insulating layer. The charge neutralizer 120 in this case is a beta or electron source. The stream of electrons 110 from the beta source is directed towards the target, and thereby removes any charge buildup.

I claim:

1. A method of producing a stream of small charged droplets that includes the following essential steps.
(a) Providing a flow of relatively non volatile electrically conducting liquid into a region in which there is an electric field sufficiently intense to disperse emerging liquid into region as a spray of small charged droplets;
(b) Providing one or more electrodes have configurations, potentials and positions such that said stream of charged droplets will flow in a desired direction at a desired velocity.
(c) Providing a target at ground potential with respect to the droplet source or vice-versa

2. A method as in claim 1 in which said electric waveshape is sine

3. A method as in claim 1 in which said electric waveshape is square

4. A method as in claim 1 in which said electric waveshape is random

5. A method as in claim 1 in which said electric waveshape changes polarity
